(19) United States
(12) Patent Application Publication
(10) Pub. No.: US 2017/0288271 A1
(43) Pub. Date: Oct. 5, 2017

(54) ELECTROLYTE SOLUTIONS FOR RECHARGEABLE BATTERIES

(71) Applicant: 3M INNOVATIVE PROPERTIES COMPANY, St. Paul, MN (US)

(72) Inventor: Dinh Ba Le, St. Paul, MN (US)

(21) Appl. No.: 15/511,256

(22) PCT Filed: Sep. 18, 2015
(86) PCT No.: PCT/US15/50843

§ 371 Date: Mar. 15, 2017

Related U.S. Application Data
(60) Provisional application No. 62/052,722, filed on Sep. 19, 2014.

(51) Int. Cl. H01M 10/0568; H01M 4/134; H01M 4/133; H01M 10/0525; H01M 10/0569

(52) U.S. Cl. CPC H01M 10/0568; H01M 10/0525; H01M 10/0569; H01M 4/133; H01M 4/134; H01M 2300/0037; H01M 2220/20

(57) ABSTRACT

An electrolyte composition includes ethyl acetate and one or more lithium salts. The ethyl acetate is present in the electrolyte composition in an amount of at least 50 volume % based on the total volume of the electrolyte composition.

### FIELD

The present disclosure relates to compositions useful as electrolytes for rechargeable batteries and methods for preparing and using the same.

### BACKGROUND

Various electrolyte solutions have been introduced for use in secondary batteries. Such compositions are described, for example, in E. Markevich, et al, Journal of The Electrochemical Society, 160 (10) A1824-A1833 (2013); and Kang Xu, Chem. Rev. 2004, 104, 4303 4417 4303.

### SUMMARY

In some embodiments, an electrolyte composition is provided. The composition includes ethyl acetate and one or more lithium salts. The ethyl acetate is present in the electrolyte composition in an amount of at least 50 volume % based on the total volume of the electrolyte composition.

In some embodiments, a method of making an electrolyte composition is provided. The method includes combining ethyl acetate and one or more lithium salts to form the electrolyte composition. The ethyl acetate is present in the electrolyte composition in an amount of at least 50 volume % based on the total volume of the electrolyte composition

In some embodiments, an electrochemical cell is provided. The electrochemical cell includes a positive electrode, a negative electrode, and an electrolyte composition as described above.

The above summary of the present disclosure is not intended to describe each embodiment of the present invention. The details of one or more embodiments of the disclosure are also set forth in the description below. Other features, objects, and advantages of the invention will be apparent from the description and from the claims.

### DETAILED DESCRIPTION

The rapid development of electronic devices has increased market demand for electrochemical devices such as fuel cells, capacitors, and battery systems. In response to the demand for battery systems in particular, practical rechargeable lithium ion batteries have been actively researched. These systems are typically based on the use of lithium metal, lithiated carbon, or an alloy as the negative electrode (anode).

Lithium ion batteries are prepared from one or more lithium ion electrochemical cells. Such cells have consisted of a non-aqueous lithium ion-conducting electrolyte composition interposed between electrically-separated, spaced-apart positive and negative electrodes. The electrolyte composition often includes a liquid solution of lithium electrolyte salt in nonaqueous aprotic organic electrolyte solvent (often a solvent mixture). Typical electrolytes consist of carbonates such as ethylene carbonate, propylene carbonate, ethyl methylene carbonate, diethylene carbonate as major solvents and vinylene carbonate and fluorinated ethylene carbonate as additives.

The selection of electrolyte solvents for rechargeable lithium batteries is crucial for optimal battery performance and involves a variety of different factors. However, long-term stability, ionic conductivity over broad temperature ranges (particularly, low temperatures), safety, wetting capability, and ability to form a conductive solid interfacial film with active solid surface (SEI/solid electrolyte interface) are important selection factors in high volume commercial applications.

Among the most common lithium electrolyte salts are LiPF₆, lithium bis(oxalato)borate, and LiN(SO₂CF₃)₂. However, use of LiN(SO₂CF₃)₂ has been limited due to its tendency to corrode aluminum current collectors at high voltage, and its high cost. Use of lithium bis(oxalato)borate has been limited due to its low solubility and low conductivity in known electrolyte solvents, such as carbonate solvents (e.g., dimethyl carbonate, ethyl methyl carbonate, diethyl carbonate).

In accordance with some embodiments of the present disclosure, electrolytes with high lithium salt concentrations (e.g., high concentrations of LiPF₆, lithium bis(oxalato)borate, or LiN(SO₂CF₃)₂) may be provided through the use of ethyl acetate as the electrolyte solvent. As will be discussed further below, in the electrolyte solutions of the present disclosure, lithium salts are soluble over a wide temperature range (e.g., down to −40° C. or lower), and the electrolyte solutions exhibit high ionic conductivity over a broad temperature range (e.g., −40° C. to 60° C.). Further, the electrolyte solutions of the present disclosure have low viscosity and, thus, provide high rate capabilities.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, the present disclosure is directed to an electrolyte solution for a rechargeable battery (e.g., rechargeable lithium ion battery). In some embodiments, the electrolyte solution may include ethyl acetate and one or more electrolyte salts.

In various embodiments, ethyl acetate may be present in the electrolyte solution as a major solvent component. For example, ethyl acetate may be present in the electrolyte solution in amount of at least 50 vol. %, at least vol. 60%, at least 70 vol. %, at least 80 vol. %, at least 90 vol. %, or at least 95 vol. %, based on the total volume of the solution. Ethyl acetate may be present in the electrolyte solution in amount of between 50 and 99 vol. %, 60 and 97 vol. %, or 70 and 97 vol. %., based on the total volume of the solution.

In illustrative embodiments, the electrolyte solutions may further include one or more minor solvent components, or co-solvents. In some embodiments, the minor solvent components may include one or more carbonates (e.g., cyclic carbonates). In various embodiments, suitable minor solvent components may include organic and fluorine-containing electrolyte solvents (for example, propylene carbonate, ethylene carbonate, dimethyl carbonate, diethyl carbonate, ethyl methyl carbonate, vinylene carbonate, fluoroethylene carbonate, dimethoxyethane, γ-butyrolactone, diethylene glycol dimethyl ether, tetraethylene glycol dimethyl ether), tetrahydrofuran, alkyl-substituted tetrahydrofuran, 1,3-dioxolane, alkyl-substituted 1,3-dioxolane, tetrahydropyran, substituted tetrahydropyran, and the like, and mixtures thereof), and esters such as methyl acetate and butyl acetate, or mixtures of any of the foregoing. The minor solvent components may be present in the electrolyte solution in an amount of up to 5 vol. %, up to 20 vol. %, up to 30 vol. %, or up to 50 vol. %, based on the total volume of the electrolyte solution.

In some embodiments, the electrolyte solution may include one or more electrolyte salts. In some embodiments, the electrolyte salts may include lithium salts and, optionally, minor amounts of other salts such as sodium salts (e.g., NaPF6). Suitable lithium salts may include LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), LiN(SO₂F)(SO₂C₄F₉), or combinations thereof. In some embodiments, the lithium salts may include LiPF6, lithium bis(oxalato)borate, LiN(SO₂CF₃)₂, or combinations thereof. In some embodiments, the lithium salts may include LiPF6 and either or both of lithium bis(oxalato)borate and LiN(SO₂CF₃)₂.

In some embodiments, any conventional electrolyte additives known to those skilled in the art may also be included in the electrolyte solutions of the present disclosure.

The present disclosure is further directed to electrochemical cells that include the above-described electrolyte solution. In some embodiments, the electrochemical cell may be a rechargeable electrochemical cell (e.g., a rechargeable lithium ion electrochemical cell) that includes a positive electrode, a negative electrode, and the electrolyte solution.

In some embodiments, the positive electrode may include a current collector having disposed thereon a positive electrode composition. The current collector for the positive electrode may be formed of a conductive material such as a metal. According to some embodiments, the current collector includes aluminum or an aluminum alloy. According to some embodiments, the thickness of the current collector is 5 μm to 75 μm. It should also be noted that while the positive current collector may be described as being a thin foil material, the positive current collector may have any of a variety of other configurations according to various exemplary embodiments. For example, the positive current collector may be a grid such as a mesh grid, an expanded metal grid, a photochemically etched grid, or the like.

In some embodiments, the positive electrode composition may include an active material. The active material may include a lithium metal oxide. In an exemplary embodiment, the active material may include lithium transition metal oxide intercalation compounds such as LiCoO₂, LiCO_{0.2}Ni_{0.8}O₂, LiMn₂O₄, LiFePO₄, LiNiO₂, or lithium mixed metal oxides of manganese, nickel, and cobalt in any proportion. Blends of these materials can also be used in positive electrode compositions. Other exemplary cathode materials are disclosed in U.S. Pat. No. 6,680,145 (Obrovac et al.) and include transition metal grains in combination with lithium-containing grains. Suitable transition metal grains include, for example, iron, cobalt, chromium, nickel, vanadium, manganese, copper, zinc, zirconium, molybdenum, niobium, or combinations thereof with a grain size no greater than about 50 nanometers. Suitable lithium-containing grains can be selected from lithium oxides, lithium sulfides, lithium halides (e.g., chlorides, bromides, iodides, or fluorides), or combinations thereof. The positive electrode composition may further include additives such as binders (e.g., polymeric binders (e.g., polyvinylidene fluoride), conductive diluents (e.g., carbon), fillers, adhesion promoters, thickening agents for coating viscosity modification such as carboxymethylcellulose, or other additives known by those skilled in the art.

The positive electrode composition can be provided on only one side of the positive current collector or it may be provided or coated on both sides of the current collector. The thickness of the positive electrode composition may be 0.1 μm to 3 mm. According to some embodiments, the thickness of the positive electrode composition may be 10 μm to 300 μm. According to another embodiment, the thickness of the positive electrode composition may be 20 μm to 90 μm.

In various embodiments, the negative electrode may include a current collector and a negative electrode composition disposed on the current collector. The current collector for the negative electrode may be formed of a conductive material such as a metal. According to some embodiments, the current collector includes copper or a copper alloy. According to another exemplary embodiment, the current collector includes titanium or a titanium alloy. According to another embodiment, the current collector includes nickel or a nickel alloy. According to another embodiment, the current collector includes aluminum or an aluminum alloy. According to some embodiments, the thickness of the current collector may be 5 μm to 75 μm. It should also be noted that while the negative current collector has been described as being a thin foil material, the negative current collector may have any of a variety of other configurations according to various exemplary embodiments. For example, the negative current collector may be a grid such as a mesh grid, an expanded metal grid, a photochemically etched grid, or the like.

In some embodiments, the negative electrode composition may include an active material. The active material may include lithium metal, carbonaceous materials, or metal alloys (e.g., silicon alloy composition or lithium alloy compositions). Suitable carbonaceous materials can include synthetic graphites such as mesocarbon microbeads (MCMB) (available from E-One Moli/Energy Canada Ltd., Vancouver, BC), SLP30 (available from TimCal Ltd., Bodio Switzerland), natural graphites and hard carbons. Suitable alloys may include electrochemically active components such as silicon, tin, aluminum, gallium, indium, lead, bismuth, and zinc and may also include electrochemically inactive components such as iron, cobalt, transition metal silicides and transition metal aluminides. In some embodiments, the active material of the negative electrode includes a silicon alloy.

In various embodiments, the negative electrode composition may further include an electrically conductive diluent to facilitate electron transfer from the composition to the current collector. Electrically conductive diluents include, for example, carbons, powdered metal, metal nitrides, metal carbides, metal silicides, and metal borides. Representative electrically conductive carbon diluents include carbon blacks such as Super P and Super S carbon blacks (both from MMM Carbon, Belgium), Shawanigan Black (Chevron Chemical Co., Houston, Tex.), acetylene black, furnace black, lamp black, graphite, carbon fibers and combinations thereof. In some embodiments, the amount of conductive diluent in the electrode composition may be at least 2 wt. %, at least 6 wt. %, or at least 8 wt. % based upon the total weight of the electrode composition. As a further example, the negative electrode compositions may include graphite to improve the density and cycling performance, especially in calendered coatings, as described in U.S. Patent Application Publication 2008/0206641 by Christensen et al., which is herein incorporated by reference in its entirety. The graphite may be present in the negative electrode composition in an amount of greater than 20 wt. %, greater than 50 wt. %, greater than 70 wt. % or even greater, based upon the total weight of the negative electrode composition. As another example, the negative electrode compositions may include a binder. Suitable binders include oxo-acids and their salts, such as sodium carboxymethylcellulose, polyacrylic acid and lithium polyacrylate. Other suitable binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Other suitable binders include polyimides such as the aromatic, aliphatic or cycloaliphatic polyimides and polyacrylates. The binder may be crosslinked. In some embodiments, the amount of binder in the electrode composition may be at least 5 wt. %, at least 10 wt. %, or at least 20 wt. % based upon the total weight of the electrode composition. The amount of binder in the electrode composition may be less than 30 wt. %, less than 20 wt. %, or less than 10 wt. % based upon the total weight of the electrode composition.

The negative electrode composition can be provided on only one side of the negative current collector or it may be provided or coated on both sides of the current collector. The thickness of the negative electrode composition may be 0.1 μm to 3 mm. According to some embodiments, the thickness of the negative electrode composition may be 10 μm to 300 μm. According to another embodiment, the thickness of the negative electrode composition may be 20 μm to 90 μm.

In some embodiments, the electrochemical cells of the present disclosure may include a separator (e.g., a polymeric microporous separator) provided intermediate or between the positive electrode and the negative electrode. The electrodes may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as another lithium ion battery configuration.

According to some embodiments, the separator can be a polymeric material such as a polypropylene/polyethelene copolymer or another polyolefin multilayer laminate that includes micropores formed therein to allow electrolyte and lithium ions to flow from one side of the separator to the other. The thickness of the separator may be between approximately 10 micrometers (μm) and 50 μm according to an exemplary embodiment. According to another exemplary embodiment, the thickness of the separator is approximately 25 μm and the average pore size of the separator is between approximately 0.02 μm and 0.1 μm.

Lithium ion batteries incorporating the electrolyte solutions of the present disclosure exhibit performance improvements relative to lithium ion batteries having conventional electrolytes (e.g., carbonate-based electrolytes). For example, such batteries may exhibit a capacity retention improvement over 100 cycles of at least 40%, at least 50%, or at least 60% relative to relative to lithium ion batteries having conventional electrolytes.

In some embodiments, in the electrolyte solutions of the present disclosure, lithium salts are highly soluble over a wide temperature range. For example, up to 2, 3, or 4 moles of LiPF₆, up to 1 mole of lithium bis(oxalato)borate, or at least 1 mole of LiN(SO₂CF₃)2 are soluble down to −20° C.

In some embodiments, the electrolyte solutions of the present disclosure exhibit high ionic conductivity over a broad temperature range. For example, the electrolyte solutions may exhibit ionic conductivity of at least 10 mS/cm, at least 5 mS/cm, or at least 2.9 mS/cm over a temperature range of 60° C. to 0° C., 60° C. to −20° C., or 60° C. to −40° C.

The disclosed electrochemical cells can be used in a variety of devices including, without limitation, portable computers, tablet displays, personal digital assistants, mobile telephones, motorized devices (e.g., personal or household appliances and vehicles), instruments, illumination devices (e.g., flashlights) and heating devices. One or more electrochemical cells of this invention can be combined to provide battery pack.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

Various electrolytes of the present disclosure were formulated with ethyl acetate (EtOAc, from Aldrich) as a major co-solvent and cyclic carbonates like vinylene carbonate (VC, from Novolyte Technologies), ethylene carbonate (EC, from Novolyte Technologies), propylene carbonate (PC, from Novolyte Technologies), fluorinated ethylene carbonate (FEC, from BASF) or gamma butyrolactone (GBL, from Aldrich) as minor co-solvents. Comparative electrolyte solvents include ethyl methyl carbonate (EMC, from Novolyte Technologies), dimethyl carbonate (DMC, from Novolyte Technologies) and diethyl carbonate (DEC, from Novolyte Technologies). Electrolyte salts included lithium hexafluorophosphate (LiPF6, from Novolyte Technologies), lithium bis(oxalate)borate (LiBOB) from Chemetall Foote Corp.), lithium bis(trifluoromethanesulfonyl)imide (LiTFSI, from 3M Company) and lithium trifluoromethanesulfonate (LiTriflate, from 3M or Aldrich).

### Examples 1-4 (Ex 1-4) and Comparative Examples 1-2 (CE 1-2)

### Conductivity Testing

The conductivity of electrolytes at various temperatures was determined. Electrolytes were formulated as outlined in Table 1 below. The conductivity of electrolytes was measured using conductivity cell from YSI Incorporated (Model 3403) and a cell constant K of 1.0/cm. The conductivity results shown in Table 1 below indicate that electrolytes comprising ethyl acetate had a higher conductivity than the comparative examples (CE), especially at low temperatures.

TABLE 1
Electrolyte conductivity at various temperatures

| | | Conductivity | | | |
|---|---|---|---|---|---|
| Example | Electrolytes | 24° C. | 0° C. | −20° C. | −40° C. |
| Ex 1 | 1M LiPF6/EtOAC | 10.1 mS/cm | 8.3 mS/cm | 6.4 mS/cm | 4.2 mS/cm |
| Ex 2 | 1M LiPF6/[10v%FEC/90v%EtOAc] | 13.5 mS/cm | 10.2 mS/cm | 7.2 mS/cm | 4.3 mS/cm |
| Ex 3 | 1M LiPF6/[30v%FEC/70v%EtOAc] | 14.5 mS/cm | 9.7 mS/cm | 6.0 mS/cm | 2.9 mS/cm |
| Ex 4 | 1M LiBOB/EtOAc | 10.7 mS/cm | 7.9 mS/cm | 5.4 mS/cm | 3.2 mS/cm |
| CE 1 | 1M LiPF6/[1EC/1EMC/1DMC] | 9.7 mS/cm | 5.7 mS/cm | 3.0 mS/cm | 1.1 mS/cm |
| CE 2 | 1M LiPF6/DEC | 2.6 mS/cm | na | na | na |

### Examples 5-49 and Comparative Example 3

### Electrochemical Cells with Alloy Anodes

The formulated electrolytes were evaluated for performance with alloy/graphite anodes in lithium ion battery cells using LiMnNiCoO2 (MNC, available as BC723k Umicore) as positive electrodes. Positive electrodes were made from 90 wt % MNC, 5 wt % SP (conductive carbon, available from TimCal) and 5 wt % PVDF (polyvinylidene fluoride binder available as Kynar 761 from ARKEMA). Alloy/Graphite negative electrodes were made from 54.7 wt % SiFeO (prepared using the low energy milling method describe in U.S. Pat. No. 8,287,772), 30.7 wt % graphite (MAGE, available from Hitachi), 2.2 wt % SP and 12.4 wt % LiPAA binder (prepared by neutralizing polyacrylic acid (Mw 250000) from Aldrich with LiOH—H2O as 10% solid in deionized water.)

Electrochemical test cells (2325 button cells) were prepared with 16-mm diameter electrodes; 20-mm diameter separator (BMF, micro fiber); 20-mm diameter separator (Celgard 2325); one 18-mm diameter copper spacer (0.75 mm thick); one 18-mm diameter aluminum spacer (0.75 mm thick) and 200 mg electrolyte as outlined in Table 2 below. Cells were assembled in a dry room (−60° C. to −80° C. dew point). Cells were tested with Maccor cycler (available from Maccor, Tulsa, Okla.) by initially charging to 4.2 volts at 10 hr rate with trickling down to 20 hour rate and 15 minute rest at the end of charging, followed by discharging to 2.8 volts at 10 hour rate and a 15 minute rest at the end. The next cycles were similar but at 4 hour rate in place of 10 hour rate. The results in Table 2 show an improvement in capacity retention after 100 cycles for cells comprising ethyl acetate in the electrolyte.

TABLE 2
Electrochemical Cell Cycling Capacity and Retention with Alloy Anodes

| | | Capacity (mAh/g) | | |
|---|---|---|---|---|
| | | Cycle 2 | Cycle 100 | Retention |
| Example | Electrolyte | Discharge | Discharge | (%) |
| CE3 | 1M LiPF6 in 25v%EC/75v%EMC | 126 | 76 | 60 |
| Ex.5 | 1M LiPF6 in 25v%VC/75v% EtOAc | 123 | 106 | 86 |
| Ex.6 | 1M LiPF6 in 25v%VC/75v% EtOAc | 122 | 108 | 89 |
| Ex.7 | 1M LiBOB in 3v%VC/97v%EtOAc | 119 | 112 | 94 |
| Ex.8 | 1M LiBOB in 5v%VC/95v%EtOAc | 120 | 113 | 94 |
| Ex.9 | 1M LiBOB in 10v%VC/90v%EtOAc | 123 | 115 | 93 |
| Ex.10 | 1.45M LiPF6 + 0.05M LiBOB in | 118 | 105 | 89 |
| | 3v%VC/97v%EtOAc | | | |
| Ex.11 | 0.75M LiPF6 + 0.25M LiBOB in | 123 | 112 | 91 |
| | 5v%VC/95v%EtOAc | | | |
| Ex.12 | 0.95M LiPF6 + 0.05M LiBOB in | 120 | 106 | 88 |
| | 5v%VC/95v%EtOAc | | | |
| Ex.13 | 1.45M LiPF6 + 0.05M LiBOB in | 120 | 108 | 90 |
| | 5v%VC/95v%EtOAc | | | |
| Ex.14 | 0.95M LiPF6 + 0.05M LiBOB in | 120 | 110 | 92 |
| | 10v%VC/90v%EtOAc | | | |
| Ex.15 | 0.90M LiPF6 + 0.10M LiBOB in | 120 | 109 | 91 |
| | 10v%VC/90v%EtOAc | | | |
| Ex.16 | 0.80M LiPF6 + 0.20M LiBOB in | 120 | 109 | 91 |
| | 10v%VC/90v%EtOAc | | | |
| Ex.17 | 0.75M LiPF6 + 0.25M LiBOB in | 120 | 111 | 93 |
| | 10v%VC/90v%EtOAc | | | |
| Ex.18 | 0.70M LiPF6 + 0.30M LiBOB in | 120 | 108 | 90 |
| | 10v%VC/90v%EtOAc | | | |
| Ex.19 | 0.67M LiPF6 + 0.33M LiBOB in | 124 | 114 | 92 |
| | 10v%VC/90v%EtOAc | | | |
| Ex.20 | 0.50M LiPF6 + 0.50M LiBOB in | 121 | 112 | 93 |
| | 10v%VC/90v%EtOAc | | | |
| Ex.21 | 0.20M LiPF6 + 0.75M LiBOB in | 121 | 111 | 92 |
| | 10v%VC/90v%EtOAc | | | |
| Ex.22 | 0.75M LiTFSI + 0.25M LiBOB in | 121 | 112 | 93 |
| | 10v%VC/90v%EtOAc | | | |
| Ex.23 | 0.67M LiTFSI + 0.33M LiBOB in | 122 | 113 | 93 |
| | 10v%VC/90v%EtOAc | | | |
| Ex.24 | 0.50M LiTFSI + 0.50M LiBOB in | 121 | 112 | 93 |
| | 10v%VC/90v%EtOAc | | | |
| Ex.25 | 0.33M LiTFSI + 0.67M LiBOB in | 123 | 114 | 93 |
| | 10v%VC/90v%EtOAc | | | |
| Ex.26 | 0.25M LiTFSI + 0.75M LiBOB in | 121 | 113 | 93 |
| | 10v%VC/90v%EtOAc | | | |
| Ex.27 | 0.75M LiTriflate + 0.25M LiBOB in | 121 | 111 | 92 |
| | 10v%VC/90v%EtOAc | | | |
| Ex.28 | (2/3)M LiTriflate + (1/3)M LiBOB in | 120 | 110 | 92 |
| | 10v%VC/90v%EtOAc | | | |
| Ex.29 | 0.50M LiTriflate + 0.50M LiBOB in | 121 | 112 | 93 |
| | 10v%VC/90v%EtOAc | | | |
| Ex.30 | (1/3)M LiTriflate + (2/3)M LiBOB in | 122 | 114 | 93 |
| | 10v%VC/90v%EtOAc | | | |
| Ex.31 | 0.25M LiTriflate + 0.75M LiBOB in | 121 | 112 | 93 |
| | 10v%VC/90v%EtOAc | | | |
| Ex.32 | (1/3)M LiPF6 + (1/3)M LiTFSI + (1/3)M | 123 | 113 | 92 |
| | LiBOB in 10v%VC/90v%EtOAc | | | |
| Ex.33 | (1/3)M LiTriflate + (1/3)M LiTFSI+ (1/3)M | 122 | 113 | 93 |
| | LiBOB in 10v%VC/90v%EtOAc | | | |
| Ex.34 | 1.5M LiPF6 in 10v%VC/90v%EtOAc | 122 | 108 | 89 |
| Ex.35 | 2.0M LiPF6 in 10v%VC/90v%EtOAc | 123 | 110 | 89 |
| Ex.36 | 1.5M LiPF6 in 25v%VC/75v%EtOAc | 121 | 110 | 91 |
| Ex.37 | 1.45M LiPF6 +0.05M LiBOB in | 119 | 110 | 92 |
| | 10v%VC/90v%EtOAc | | | |
| Ex.38 | 1.95M LiPF6 + 0.05M LiBOB in | 117 | 108 | 92 |
| | 10v%VC/90v%EtOAc | | | |
| Ex.39 | 1.25M LiPF6 + 0.25M LiBOB in | 122 | 112 | 92 |
| | 10v%VC/90v%EtOAc | | | |
| Ex.40 | 1.75M LiPF6 + 0.25M LiBOB in | 119 | 110 | 92 |
| | 10v%VC/90v%EtOAc | | | |
| Ex.41 | 1.0M LiBOB in 20v%PC/80v%EtOAc | 123 | 112 | 91 |
| Ex.42 | 1.0M LiBOB in 10v%PC/90v%EtOAc | 122 | 111 | 91 |
| Ex.43 | 1.0M LiBOB in | 122 | 113 | 93 |
| | 12.5v%EC/12.5v%PC/75v%EtOAc | | | |
| Ex.44 | 1.2M LiBOB in | 122 | 113 | 93 |
| | 12.5v%EC/12.5v%PC/75v%EtOAc | | | |
| Ex.45 | 1.5M LiBOB in | 120 | 112 | 93 |
| | 12.5v%EC/12.5v%PC/75v%EtOAc | | | |
| Ex.46 | 1.5M LiBOB in | 122 | 114 | 93 |
| | 5v%EC/10v%PC/85v%EtOAc | | | |
| Ex.47 | 1.0M LiPF6 in | 122 | 107 | 88 |
| | 12.5v%PC/12.5v%VC/75v%EtOAc | | | |
| Ex.48 | 1.0M LiBOB in | 121 | 117 | 97 |
| | 10v%GBL/90v%EtOAc | | | |
| Ex.49 | 1.0M LiPF6 in | 123 | 110 | 89 |
| | 10v%FEC/7.5v%EC/7.5v%PC/75v%EtOAc | | | |

### Example 50-52 and Comparative Example 4 (CE 4)

### Electrochemical Cells with Graphite Anodes

Electrolytes were formulated with ethyl acetate as major co-solvent and cyclic carbonate such as vinyl carbonate and fluorinated ethylene carbonate as minor co-solvents and LiPF6, LiBOB, LiTFSI and Li triflate as lithium salts. The formulated electrolytes were evaluated for performance in lithium ion battery cells using LiMnNiCoO2 (MNC) as the positive electrode and graphite as the negative electrode.

Positive electrodes were made from 90 wt % MNC, 5 wt % SP (conductive carbon) and 5 wt % PVDF (binder). Graphite negative electrodes were made from 96 wt % graphite, 2.2 wt % SBR (Synthetic rubber; X-3 available from ZEON, KY, US) and 1.8 wt % CMC binder (CMC DAICEL 2200, available from Daicel Fine Chemical Ltd., Japan).

Electrochemical test cells (2325 button cells) were prepared with 16-mm diameter electrodes; 20-mm diameter separator (BMF, micro fiber); 20-mm diameter separator (Celgard 2325); one 18-mm diameter copper spacer (0.75 mm thick); one 18-mm diameter aluminum spacer (0.75 mm thick) and 200 mg of electrolyte as outlined in Table 3 below. Cells were assembled in a dry room (−60° C. to −80° C. dew point). Cells were tested with Maccor cycler. The cells were cycled from 2.8 V to 4.2V at C/4 rate (4 hr rate) with trickle charge to C/20 (20 hr rate) and 15 minute rest at the end of charge and discharge at room temperature.

Cell impedance was calculated from cell voltage change during the rest according to:

Area Specific Impedance=ASI(ohm.cm2)=voltage change(V)×current(Amp, before rest)×2.01 cm²(where 2.01 cm² is the electrode active area). Two values of cell impedance were calculated from cell voltage change after 10 milisec(0.1 second)rest and 15 minute rest from the end of discharge.

The cycling capacity results for cells with graphite electrodes are shown in Table 3 below. These results indicate better capacity retention for cells with ethyl acetate based electrolyte in comparison to conventional carbonate electrolyte (25v % EC/75v % EMC +wt % VC)

TABLE 3
Electrochemical Cell Cycling Capacity and Retention
with Graphite Anodes

| | | Capacity (mAh/g) | | |
|---|---|---|---|---|
| | | Cycle 2 | Cycle 185 | Retention |
| Example | Electrolyte | Discharge | Discharge | (%) |
| CE4 | 1M LiPF6 in | 145 | 118 | 81 |
| | 25v%EC/75v%EMC + | | | |
| | 2 wt % VC | | | |
| Ex.50 | 1M LiPF6 in | 148 | 121 | 82 |
| | 3v%VC/97v%EtOAc | | | |
| Ex.51 | 1M LiPF6 in | 146 | 128 | 88 |
| | 10v%VC/90v%EtOAc | | | |
| Ex 52 | 1M LiBOB in | 119 | 112 | 94 |
| | 25v%VC/75v%EtOAc | | | |

The impedance of the formulated electrolyte in the cells prepare with graphite anodes was measured at 10-milisecond ASI (ohm.cm²) and at 15-minute ASI (ohm.cm²). The ASI's were calculated from change in cell voltage (10-milisecond and 15-minute after cells rested at open circuit, respectively) over the applied current density (Ampere/cm2). The results are shown in Tables 4 and 5 below. These results indicate cell impedance was typically lower, which is preferable, with ethyl acetate-based electrolytes

TABLE 4
Impedance Measurements at 10-milisecond ASI (ohm · cm²)

| | | 10-milisecond ASI | |
|---|---|---|---|
| | | (ohm · cm²) | |
| | | Cycle 2 | Cycle 185 |
| Example | Electrolyte | Discharge | Discharge |
| CE4 | 1M LiPF6 in | 39 | 36 |
| | 25v%EC/75v%EMC + 2 wt % VC | | |
| Ex.50 | 1M LiPF6 in | 28 | 28 |
| | 3v%VC/97v%EtOAc | | |
| Ex.51 | 1M LiPF6 in | 32 | 32 |
| | 10v%VC/90v%EtOAc | | |
| Ex 52 | 1M LiBOB in | 32 | 36 |
| | 25v%VC/75v%EtOAc | | |

TABLE 5
Impedance Measurements at 15-minute ASI (ohm · cm²)

| | | 15-minute ASI | |
|---|---|---|---|
| | | (ohm · cm²) | |
| | | Cycle 2 | Cycle 185 |
| Example | Electrolyte | Discharge | Discharge |
| CE4 | 1M LiPF6 in | 742 | 497 |
| | 25v%EC/75v%EMC + 2 wt % VC | | |
| Ex.50 | 1M LiPF6 in | 702 | 434 |
| | 3v%VC/97v%EtOAc | | |
| Ex.51 | 1M LiPF6 in | 685 | 402 |
| | 10v%VC/90v%EtOAc | | |
| Ex 52 | 1M LiBOB in | 688 | 418 |
| | 25v%VC/75v%EtOAc | | |

1. An electroltye composition comprising:
ethyl acetate;
one or more lithium salts;
a minor solvent component comprising vinylene carbonate;
wherein the ethyl acetate is present in the electrolyte composition in an amount of at least 50 volume % based on the total volume of the electrolyte composition; and
wherein the minor solvent component is present in the electrolyte composition in an amount of up to 30 vol. % based on the total volume of the electrolyte composition.

2. The electrolyte composition of claim 1, wherein the ethyl acetate is present in the electrolyte composition in an amount of at least 75 volume % based on the total volume of the electrolyte composition.

3. The electrolyte composition of claim 1, wherein the one or more lithium salts comprise any or all of LiPF6, lithium bis(oxalato)borate, or LiN(SO₂CF₃)₂.

4. The electrolyte composition of claim 1, wherein the one or more lithium salts comprise LiPF6 and either or both of lithium bis(oxalato)borate and LiN(SO₂CF₃)₂.

5. (canceled)

6. (canceled)

7. A method of making an electrolyte composition, the method comprising:
combining ethyl acetate, a minor solvent component comprising vinylene carbonate, and one or more lithium salts to form the electrolyte composition;
wherein the ethyl acetate is present in the electrolyte composition in an amount of at least 50 volume % based on the total volume of the electrolyte composition; and
wherein the minor solvent component is present in the electrolyte composition in an amount of up to 30 vol. % based on the total volume of the electrolyte composition.

8. An electrochemical cell comprising:
a positive electrode;
a negative electrode; and
an electrolyte composition according to claim 1.

9. The electrochemical cell according to claim 8, wherein the positive electrode comprises an active material, and wherein the active material of the positive electrode comprises nickel, manganese, and cobalt.

10. The electrochemical cell according to claim 8, wherein the negative electrode comprises an active material, and wherein the active material of the negative electrode comprises silicon alloy.

11. (canceled)
